(19) United States
(12) Patent Application Publication
(10) Pub. No.: US 2010/0236073 A1
(43) Pub. Date: Sep. 23, 2010

(54) Electric Razors

(75) Inventors: Edward Neill Forsdike, Berkshire (GB); Christopher John Stevens, Berkshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: THE GILLETTE COMPANY, Boston, MA (US)

(21) Appl. No.: 11/989,819

(22) PCT Filed: Aug. 3, 2006
(86) PCT No.: PCT/IB2006/052691

§ 371 Date: Jun. 4, 2010

(30) Foreign Application Priority Data
Aug. 5, 2005 (GB) 0516188.0

(51) Int. Cl. B26B 19/38; B26B 19/20; B26B 19/02

(52) U.S. Cl. 30/43.2; 30/43; 30/43.92

(57) ABSTRACT

An electric razor comprises an apertured foil for (1) contact with skin being shaved, and an undercutter (23) urged against the foil and movable relative to the foil, in a direction parallel to a longitudinal axis of the foil, for shearing hairs that protrude through the foil apertures. The foil has a ridge (12) extending along the foil with first and second foil portions (8,9) forming respective flanks of the ridge. The cross-section of the foil is in a plane normal to the longitudinal axis and has an asymmetric arched profile. A first segment (5) of the cross-section taken through the first foil portion (8) has a radius of curvature in the range of 0.5 to 3.0 mm. A second segment (6) of the cross-section taken through the second foil portion (9) is contiguous with the first portion and has a radius of curvature in the range of 5 to 30 mm. The undercutter is in contact with the foil portions at both flanks of the ridge.

### FIELD OF THE INVENTION

This invention is concerned with electric razors of the general type comprising an apertured foil for contact with the skin being shaved, and an undercutter movable relative to the foil for shearing hairs that protrude from the skin surface and through the foil apertures.

### BACKGROUND OF THE INVENTION

The combination of an outer foil and an undercutter can be very effective in cutting short hairs, but it tends to be less effective in cutting longer hairs. There have been many proposals for the construction of electric razors to provide for cutting longer hairs as well as shorter hairs. Representative of such prior proposals are those described in the following documents:—

U.S. Pat. No. 4,835,861 (Mahlich) discloses an electric razor having a hair trimmer mounted to the razor handle separately to the foil and undercutter, the trimmer being movable between operative and inoperative positions so that the trimmer can be extended when it is desired to cut long hairs.

U.S. Pat. No. 4,493,149 (Tanahashi et al) describes an electric razor having semicylindrical foil with a bent part defining either a groove or a ridge extending along the foil, the undercutter being relieved at the position of the inwardly deformed foil region forming the groove, or projecting into the recess behind the ridge. The foil is slotted in the area of the groove or ridge for penetration by long hairs.

U.S. Pat. No. 4,481,711 (Pach et al) describes an electric razor with a so-called comb-shaving section disposed alongside the foil or cutting long hairs. Two undercutters are provided and respectively cooperate with the foil and the comb-section. The comb-section has a planar top surface that lies at an obtuse angle to a plane tangential to the foil at the location where the respective shaving sections meet so that the two sections are usable simultaneously. The razor is also equipped with a long-hair trimmer.

U.S. Pat. No. 3,517,441 (Futterer et al) refers to an electric razor having an outer foil with a part-cylindrical short-hair zone and long-hair zones with larger holes at the longitudinal marginal edges of the short hair zone, where the foil is bent abruptly at about 90° to extend inwardly. The undercutter is an inner foil having cutting openings for cooperation with the outer foil at the short-hair zone and having teeth for cooperation with the outer foil at the long hair zones. Similar foil assemblies are disclosed in U.S. Pat. No. 3,577,441 (Futterer) and U.S. Pat. No. 3,605,264 (Futterer).

U.S. Pat. No. 2,975,516 (Heyek) describes a dry shaver head including an outer shear plate with a cylindrically curved medial portion and formed with teeth along at least one of its longitudinal edges. An inner cutter assembly includes one part that cooperates with the curved portion of the shear plate, and another part that is flat and is provided with cutter teeth that cooperate with the teeth on the shear plate.

U.S. Pat. No. 3,390,454 (Godefroy) refers to an electric razor provided with an outer shaving plate having a cross-sectional profile that is asymmetrical for providing different curvatures to suit shaving different facial skin areas, including a portion of circular curvature, a flattened portion and two strongly curved portions on either side of the flattended portion. The undercutter is pivotably mounted adjacent one side and urged into engagement with the shaving plate by a spring positioned at the other side so that the resistance to local inward displacement of the shaving plate varies around the circumference. The strongly curved portions are intended for use on throat and cheek areas where they can be used to exert a strong local pressure to encourage hairs to stand up.

JP-A-42-4197 (Tanaka et al) proposes an outer foil for an electric shaver having a thicker portion with a right angle bend and including slots that extend to both sides of the bend, and a thinner portion with circular holes. The thicker portion is intended for clipping long hairs and the thinner portion for cutting short hairs. An external step is defined along the foil between the thicker and thinner portions and is said to assist in stretching the skin A right angle bend is not conducive to comfort and whilst the increased foil thickness in this region could alleviate this drawback it has either complications in manufacture and presents difficulties in ensuring the required close cooperation with an undercutter.

### SUMMARY OF THE INVENTION

In spite of the many prior proposals there remains a need for a structurally simple form of electric razor head that is capable of cutting efficiently both longer and shorter hairs. This need is addressed by the present invention according to a first aspect of which there is provided an electric razor comprising an apertured foil for contact with the skin being shaved, and an undercutter urged against the foil and movable relative to the foil, in a direction parallel to a longitudinal axis of the foil, for shearing hairs that protrude through the foil apertures, the foil having a ridge extending along the foil with first and second foil portions forming respective flanks of the ridge, characterised in that the cross-section of the foil in a plane normal to the longitudinal axis has an asymmetric arched profile, a first segment of the cross-section taken through the first foil portion has a radius of curvature in the range of 0.5 to 3.0 mm, and a second segment of the cross-section taken through the second foil portion is contiguous with the first portion and has a radius of curvature in the range of 5 to 30 mm, and the undercutter is in contact with the foil portions at both flanks of the ridge.

In accordance with a second aspect the invention provides an electric razor foil including an area with apertures, an outer surface for contact with the skin during shaving, and an inner surface for shearing cooperation with an undercutter to shear hairs that protrude through the foil apertures, and a ridge extending across the apertured area with first and second foil portions forming respective flanks of the ridge, the first foil portion having apertures in the form of slots elongate in a direction transverse to the ridge, and the foil having a cross-section transverse to the length of the ridge that is uniform along the length of the ridge, characterised in that the foil cross-section has an asymmetric arched profile, a first segment of the cross-section taken through the first foil portion has a radius of curvature in the range of 0.5 to 3.0 mm, and a second segment of the cross-section taken through the second foil portion is contiguous with the first segment and has a radius of curvature in the range of 5 to 30 mm.

In a preferred construction the second segment of the arched profile of the foil cross-section comprises an arc with a radius of curvature in the range of from 5 to 15 mm, preferably 7.5 to 12.5 mm, for example, about 10 mm. The first segment of the arched profile, in the preferred construction, is an arc with a radius of curvature not greater that 2 mm, preferably in the range of 0.5 to 1.5 mm, such as about 1 mm.

The foil portion with the small radius of curvature is especially effective in the removal of low-lying hairs that are often found in the neck area, because it improves the efficiency of longer hairs being fed into the foil apertures which is essential for the hairs to be cut. The foil portion with the larger radius of curvature can provide more comfortable short hair feeding and shave finishing. By the foil and undercutter being configured to enable longer as well as shorter hairs to be picked up and shaved with good efficiency, the need for a separate trimmer is obviated. The foil shape is such that the portion of small radius can lead the portion of larger radius over a skin area being shaved to provide effective cutting of long and short hairs without need for distinct shaving parts of the razor to be applied in turn to the skin, or for the razor to require particular manipulation in the hand of a user to bring the respective parts into shaving contact with the skin. With the radius of curvature of the foil portion with the smaller radius of curvature being not less than 0.5 mm satisfactory levels of comfort can still be ensured and effective cooperation between the undercutter and both foil portions can be achieved without difficulty. The foil can be made with a uniform thickness over the apertured area so that the thickness at the first foil portion is substantially equal to the foil thickness at the second foil portion. In addition, the outer surface of the foil preferably has a smooth transition across the peak of the ridge from the first to the second foil portion.

The ability of the smaller radius foil portion to feed hairs into the foil apertures is enhanced by the foil being provided with slots in this region, the slots being spaced apart along the foil, i.e. in the direction of the longitudinal axis, and the slots being elongated in a direction transverse to the axis. A preferred foil includes slots that extend from a position substantially at the peak of the ridge, and there can be long and short slots arranged in a regular pattern. Suitable slot dimensions are 0.1 to 0.6 mm in width and up to 2.5 mm in length. In exemplary embodiments there are at least some slots having a width of from 0.2 to 0.3 mm and/or at least some slots having a width of 0.3 to 0.5 mm. The slots can have a length of from 1 to 2.5 mm, for example 1.5 to 2 mm, and/or at least some slots can have a length less than 1 mm, e.g. from 0.4 to 0.7 mm. Adjacent slots are appropriately separated by a distance of 0.1 to 0.3 mm, with the slots being disposed along the foil at a pitch distance of 0.3 to 0.7 mm.

The first and second segments of the arched profile of the foil cross-section can be defined by a hyperbola. A third segment that is straight can be located adjoining the first segment at the side remote from the second segment, the third segment of the cross-section being taken through a flat foil portion. At least some of the aforementioned slots can continue beyond the first portion and into the flat third foil portion. The circumference of the arched profile is preferably such that each of the first and second segments subtend angles of 60° to 120°, preferably 75° to 105°, particularly about 90° at their centres of curvature.

To ensure effective cooperation between the foil and the undercutter in the foil portion with the smaller radius of curvature as well as in the foil portion with the larger radius of curvature, the undercutter is preferably urged by a spring force against the underside of the foil in a direction towards the ridge peak, i.e. the intersection between the first and second portions. The directional spring bias can be exerted by a first spring, e.g. a coil spring, that urges the undercutter in a first direction towards the foil, and second spring that urges the undercutter in a direction generally perpendicular to the first direction so that the resultant spring force is directed generally towards the ridge peak and towards the flat third portion

The foil is conveniently carried by a frame, and in a particular embodiment the frame carries comb elements for cooperation with the foil portion with the smaller radius of curvature.

Although an electric razor in accordance with the invention can remove long and short hairs without requiring any adjustment, the razor may be provided with a component that confronts the foil, the foil and the component being adjustable relative to each other to vary the exposure of the foil portion having the smaller radius of curvature for contact with the skin. Such an arrangement can make it possible to vary the exposure of long hair slots provided in the foil portion with the smaller radius of curvature. In addition a component positioned against the flat foil portion can assist in ensuring effective contact between the undercutter and the foil in this region.

### DESCRIPTION OF THE DRAWINGS

To facilitate a clear understanding of the invention some preferred embodiments are described below with reference to the accompanying drawings, in which

FIG. 1 shows in plan view a flat foil blank;

FIG. 2 is a cross-sectional through the foil after having been shaped in accordance with the invention;

FIG. 3A is an isometric view showing the foil wrapped around a former for shaping the foil;

FIG. 3B is a isometric view showing the shaped foil on removal from the former;

FIG. 4 is an exploded view of a shaving head of an electric razor embodying the invention;

FIG. 5 is an end elevation of the foil and support frame assembly;

FIG. 6 is a front elevation of the foil and support frame assembly;

FIG. 7 is an isometric view of the foil and support frame assembly;

FIG. 8 is a plan view of a foil bank having a first preferred slot pattern;

FIG. 9 is an enlarged view of one group of slots in the foil of FIG. 8,

FIG. 10 is a plan view of a foil blank having a second preferred slot pattern;

FIG. 11 is an enlarged view showing a group of slots included in the foil of FIG. 10; and

FIG. 12 is a perspective view illustrating a modified foil arrangement.

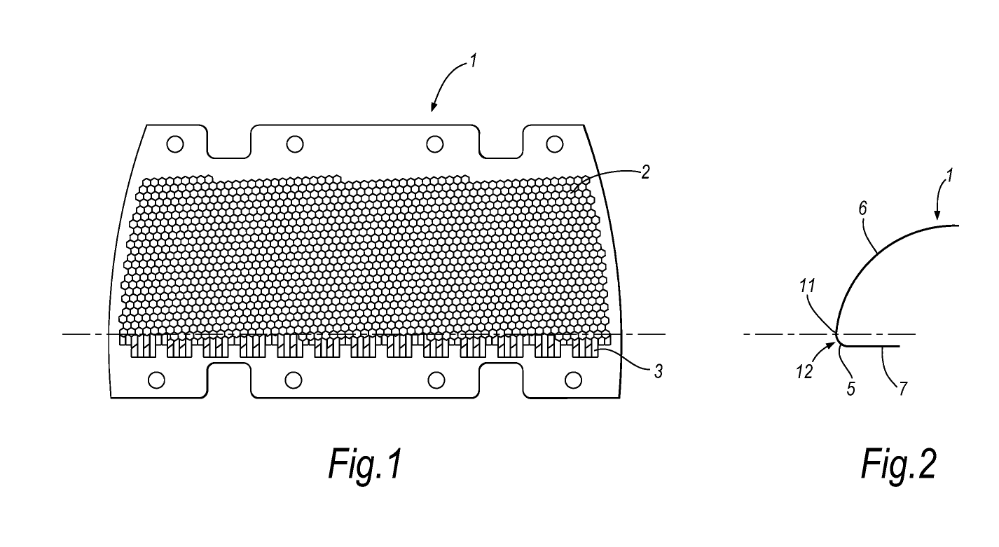

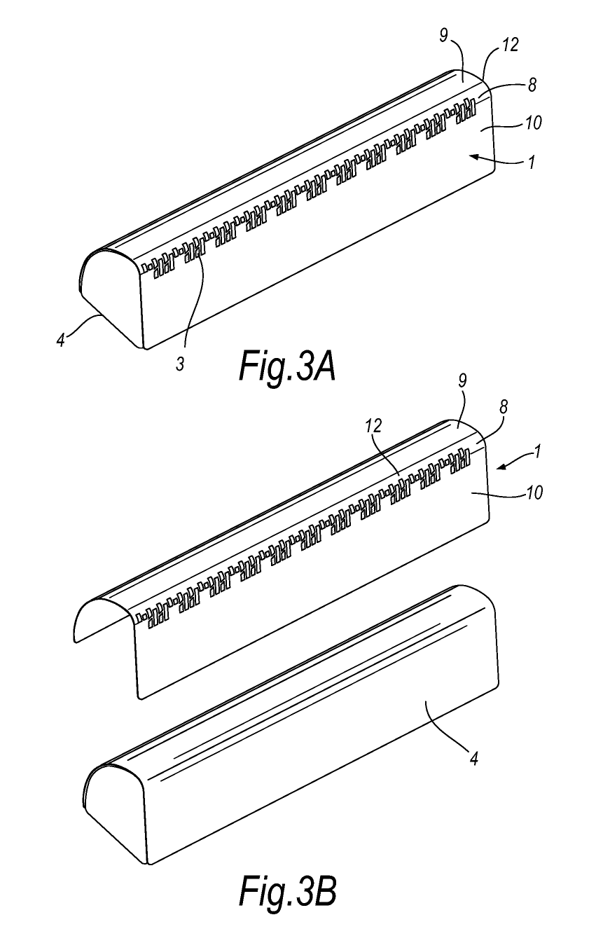

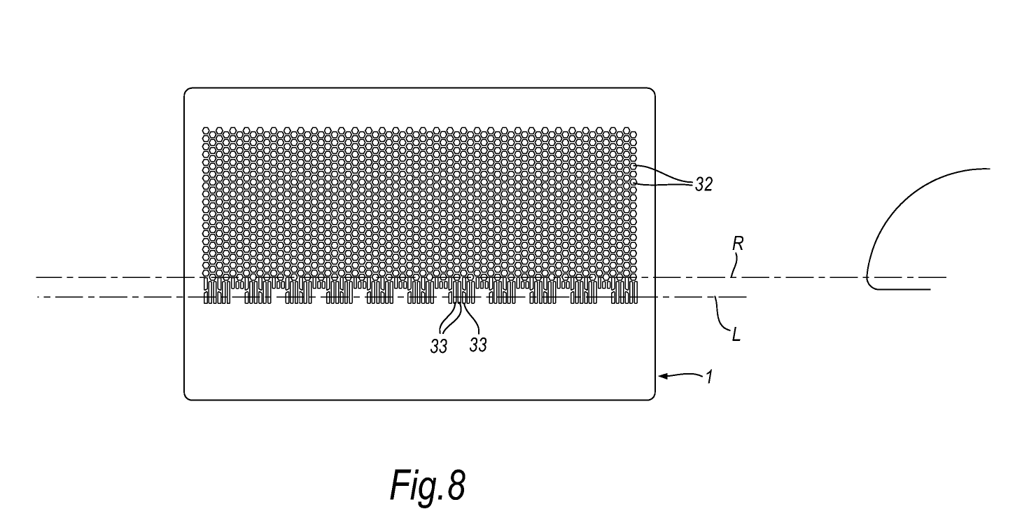

There is illustrated in FIG. 1 an apertured foil 1 for use in a shaving head assembly in or for an electric razor embodying the invention. The foil 1 is prepared in flat form with a pattern of through holes, described in more detail below with reference to FIGS. 8-11, including a main area with a regular pattern of close-packed holes 2 of circular or polygonal shape, and a marginal area with holes 3 having a more elongated slot-like form. The initially flat foil preform shown in FIG. 2 is shaped, for example by wrapping the foil around a shaped former 4, as illustrated in FIG. 3A, so that when the foil 1 is removed from the former 4 it retains the shape of the former, as can be seen in FIG. 3B. As so formed the foil acquires a predetermined cross-sectional profile which is curved and which is uniform along the length of the foil and is as shown in FIG. 2. The cross-sectional profile has an asymmetrical arched shape including a first segment 5 at which the radius of curvature is in the range of 0.5 to 3.0 mm and preferably not greater than 2.0 mm. Contiguous with the curved first segment 5, and directly adjoining the first segment in the illustrated embodiment, is a second segment 6 that is also curved, but at which the radius of curvature is not less that 5 mm and not greater than 30 mm, preferably not greater than 15 mm. In particular, the first segment 5 is an arc with a constant radius of curvature in the range of 0.5 to 1.5 mm., specifically 1.0 mm, and the second segment 6 is an arc with a constant radius of curvature in the range of 7.5 to 12.5 mm, specifically 10.0 mm. The arc of the first segment 5 subtends an angle in the range of 60° to 120°, more exactly 90°, at its centre of curvature, and the arc of the second segment 6 also subtends an angle of 60° to 120°, more precisely about 90°, at its centre of curvature. Due to the different radii of curvature the second segment 6 defines a much greater circumferential length in the shaped foil than the first segment 5. A straight or rectilinear third segment 7 of the cross-sectional profile adjoins the first arcuate segment 5 at the end remote from the second arcuate segment 6. Considered in the three dimensional form of the complete foil, the first segment 5 of the cross-section is taken through a part-cylindrical first foil portion 8 with a small radius of curvature, the second segment 6 of the cross-section is taken through a part-cylindrical second foil portion 9 with a larger radius of curvature, and the third segment 7 is taken through a flat foil portion 10. The first and second foil portions 8,9 form respective flanks of a ridge (12) that extends across the apertured area of the foil. The first and second foil portions meet at a peak 11 of the ridge 12 that extends longitudinally along the foil and coincides with this tip of the arched cross-sectional profile.

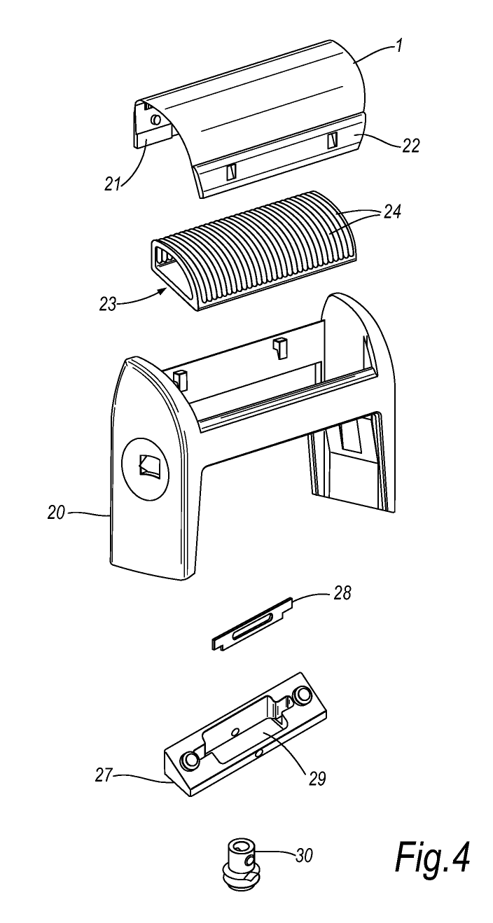

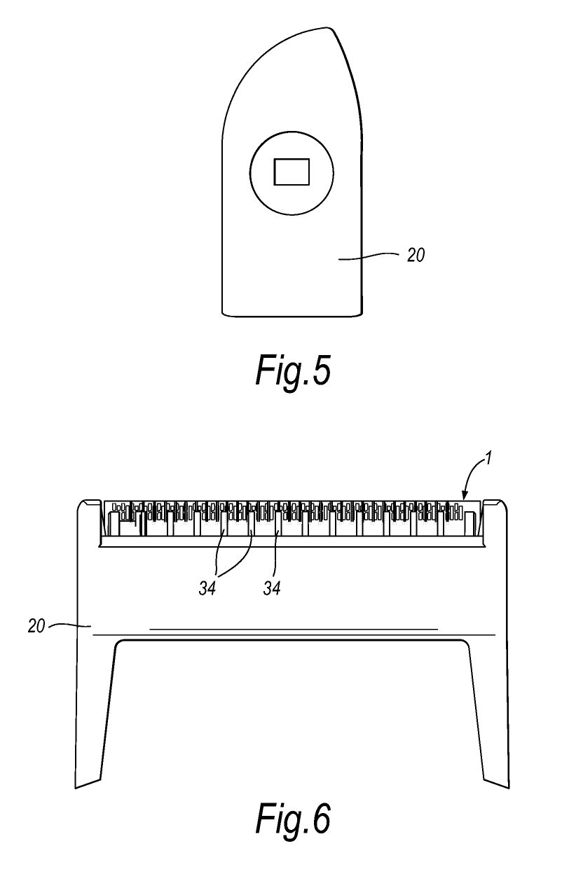

The shaped foil 1 is mounted in a moulded plastic frame 20 (FIG. 4). Reinforcing bars 21, 22 are firmly attached to the foil 1 along its longitudinal edges, such as by welding or riveting, and the sub-assembly of foil and the reinforcing bars is able to float vertically within the frame 20. An undercutter 23 is urged against the inner surface of the foil, it being important to maintain contact between the undercutter and the foil for efficient cutting of hairs. The undercutter is spring loaded against the foil and, in use, they can float together to avoid separation. As shown the undercutter 23 has a series of blade elements 24 spaced apart along its length for cooperation with the inner surface of the foil 1 so that when the undercutter 23 is reciprocated along an axis extending longitudinally of the foil, in a manner well known per se, hairs protruding through the holes 2, 3 in the foil are sheared between the edges of these holes and the edges of the cutting elements 24. The undercutter 23 is spring biased into cooperation with the foil 1 and in accordance with one of the novel aspects of the invention the spring force urging the undercutter against the foil is directed towards the ridge peak 11 so that the undercutter 23 is pressed against the underside of the foil at both flanks of the ridge 12 and thereby an effective shearing action is ensured at both the first and second curved foil portions 8, 9 and at the flat foil portion 10. The undercutter can be urged upwardly by a coil spring in a manner known per se, and an additional lateral spring force can be applied to ensure a resultant spring force in the desired direction towards the ridge peak 11. The lateral spring force is conveniently imparted to a cutter mount 27, e.g. by a leaf spring 28 supported in a cutter mount. The leaf spring 28 spans an opening 29 in the cutter mount 27 to act between a centre runner 30 that projects through the opening 29 and the cutter mount 17. The force of the leaf spring 28 is transferred to the undercutter 23 by the cutter mount. It will be understood that the upper edges of the blade elements 24 are configured to conform closely to the surface of the foil 1 with which the edges of the cutting elements 24 cooperate for shearing hairs. Of course alternative arrangements are possible to provide the spring force in the desired direction, such as a spring associated with an angled drive pin directed towards the ridge peak, or a spring integrated into the outer mount.

In use of the razor the undercutter 12 is driven by an electric motor to reciprocate back and forth along the foil. If the razor head is moved across a skin surface with the first foil portion 8 having the smaller radius of curvature leading the second foil portion 9 with the large radius of curvature, the free ends of longer hairs and low-lying hairs are caused to move away from the skin surface and to enter the holes 3 of the foil 1 in order to be severed by the shearing action of the undercutter 23 against the foil. The second foil portion 9 having the larger radius is effective for comfortable short hair cutting and shave finishing. Of course it is possible for the razor to be held and moved over the skin surface so that only the second foil portion 9 contacts the skin, which might for instance be desirable in the final stages of shaving.

To facilitate the feeding of long hairs into the foil apertures the foil is provided with slots 3 in the first foil portion 8 having the small radius of curvature. The slots 3 are elongated in a direction away from the ridge peak and transverse to the longitudinal direction of the reciprocal motion of the undercutter. At least some slots can extend from a position at the peak ridge 11 of the foil and at least some slots may extend beyond the first foil portion 8 and into the flat third foil portion 10.

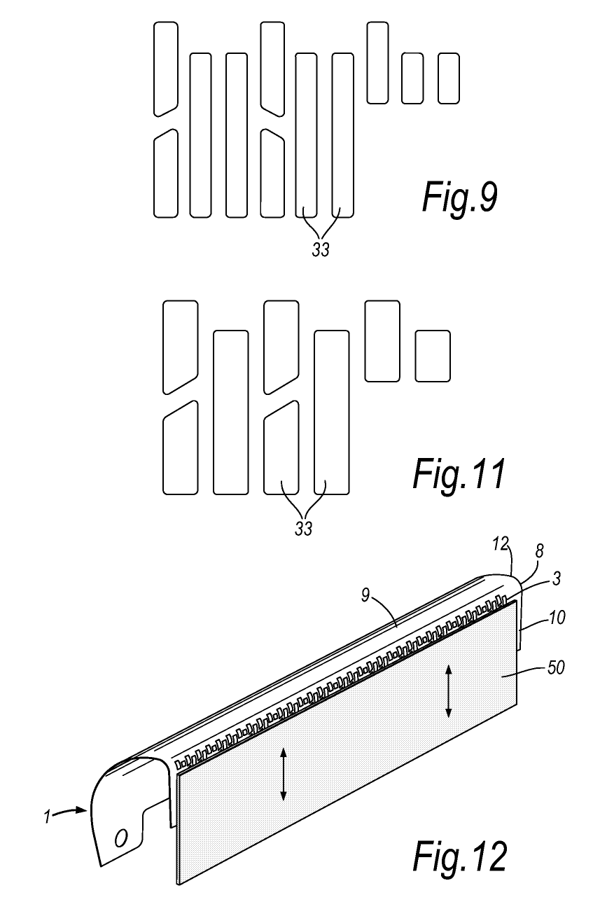

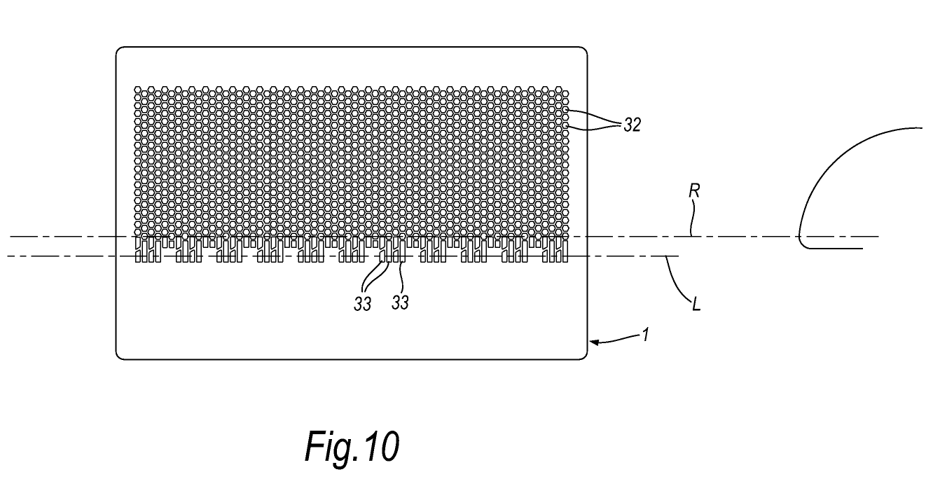

Two exemplary foil hole patterns are illustrated in FIGS. 8-11. In each of FIGS. 8 and 10 the position at which the ridge peak will be formed is indicated by a broken line R. The second broken line L indicates the location at which the first foil portion 8 meets the flat foil portion 10 in the finally shaped foil. In each foil the hole pattern includes a regular array of hexagonal holes 32 forming a honeycomb foil pattern in the area that will form the second foil portion 9 having the large radius of curvature. Adjacent to and along one side of the honeycomb pattern is a series of slots 33, these slots being in the area that will form the first foil portion 8 having the small radius of curvature, the slots being elongated and extending away from the ridge peak in the direction perpendicular to the length of the foil. In the foil of FIGS. 8 and 9 the slots 33 are uniformly spaced apart at a distance of 0.125 mm and are 0.25 mm wide giving a slot pitch of 0.375 mm. The slots are arranged in a regular pattern of long and short slots, the longest slots being 2.075 mm in length and the shortest being 0.50 mm in length. The slots in the foil of FIGS. 10 and 11 are also arranged in a regular pattern of short and long slots. In this case the slots are 0.39 mm wide and are positioned at a pitch distance of 0.56 mm. Once again the longest slots are 2.075 mm in length and the shortest slots have a length of 0.5 mm.

The electric razor particularly described above has a shaving head with a single foil and undercutter. In another embodiment two foils with respective undercutters can be positioned alongside each other, such as with their respective first foil portions 8 having the smaller radii of curvature facing towards each other. In such a construction the foils could be positioned with their ridge peaks at the same or at different heights. Another possibility is to have the height of at least one of the two foils adjustable to vary exposure of the first portion 8 of one or both foils. In addition, the first foil portions of the respective foils could be provided with different curvatures and/or different slot patterns to produce different shaving characteristics.

Illustrated in FIG. 12 is an alternative embodiment in which a plate-like member 50 is positioned against the flat portion 10 of a foil 1 and is adjustable as indicated by the arrows, to adjust the exposure of the first foil portion 8 for contact with the skin being shaved.

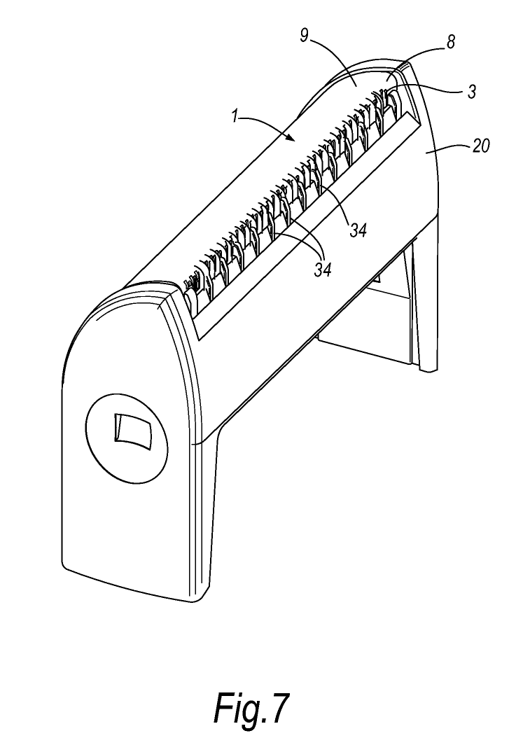

It should be understood that the foregoing description of the preferred embodiments is given by way of non-limiting example only and that modifications and variations are possible without departing from the scope of the invention as defined by the claims which follow. For instance it is not essential for there to be an abrupt change in radius of curvature from the first to the second foil portions and a gradual change is a possible alternative. Thus, the first and second arcuate segments of the cross-sectional profile of the foil can be defined by a hyperbola. As shown in FIGS. 6 and 7 the frame 20 includes comb elements 34 that extend upwardly over the flat foil portion 10 to the strongly curved first foil portion 8. Such comb elements may be beneficial in guiding the skin flow to the slotted foil portion 8.

### LIST OF REFERENCE NUMERALS

1. Foil
2. Holes
3. Slots
4. Former
5. First cross-sectional profile segment
6. Second cross-sectional profile segment
7. Third cross-sectional profile segment
8. First foil portion
9. Second foil portion
10. Third foil portion
11. Peak of profile
12. Ridge
20. Frame
21. Reinforcing bar
22. Reinforcing bar
23. Undercutter
24. Blade elements
27. Cutter mount
28. Leaf spring
29. Opening
30. Centre runner
32. Hexagonal holes
33. Slots
34. Comb elements
50. Plate-like member
R. Location of ridge peak
L. Location at which first and third foil portions meet

What is claimed is:

1. An electric razor comprising an apertured foil (1) for contact with the skin being shaved, and an undercutter (23) urged against the foil and movable relative to the foil, in a direction parallel to a longitudinal axis of the foil, for shearing hairs that protrude through the foil apertures, the foil having a ridge (12) extending along the foil with first and second foil portions (8, 9) forming respective flanks of the ridge, characterised in that the cross-section of the foil in a plane normal to the longitudinal axis has an asymmetric arched profile, a first segment (5) of the cross-section taken through the first foil portion (8) has a radius of curvature in the range of 0.5 to 3.0 mm, and a second segment (6) of the cross-section taken through the second foil portion (9) is contiguous with the first portion and has a radius of curvature in the range of 5 to 30 mm, and the undercutter (23) is in contact with the foil portions at both flanks of the ridge (12).

2. An electric razor according to claim 1, wherein the second segment (6) of the foil cross-section comprises an arc with a radius in the range of 5 to 15 mm.

3. An electric razor according to claim 1 wherein the second segment (6) of the foil cross-section comprises an arc with a radius in the range of 7.5 to 12.5 mm.

4. An electric razor according to claim 1, wherein the second segment (6) of the foil cross-section comprises an arc with a radius of about 10 mm.

5. An electric razor according to any one of the preceding claims wherein the first segment (5) of the foil cross-section comprises an arc with a radius of curvature not greater than 2 mm.

6. An electric razor according to any one of the preceding claims wherein the first segment (5) of the foil cross-section comprises an arc with a radius of curvature in the range of 0.5 to 1.5 mm.

7. An electric razor according to any one of the preceding claims wherein the first segment (5) of the foil cross-section comprises an arc with a radius of curvature of about 1 mm.

8. An electric razor according to any one of the preceding claims, wherein the foil surface has a smooth transition across the peak of the ridge from the first to the second foil portion.

9. An electric razor according to any one of the preceding claims, wherein the foil has a thickness at the first foil portion substantially equal to the foil thickness at the second foil portion.

10. An electric razor according to any one of the preceding claims, wherein the foil has slots (3) in the first foil portion (8), the slots being spaced apart along the foil in the direction of said axis and being elongated in a direction transverse to said longitudinal axis.

11. An electric razor according to claim 10, wherein at least some slots (33) extend from a position substantially at the peak (11) of the ridge (12).

12. An electric razor according to claim 10 or 11, wherein at least some slots (33) have a width of from 0.1 to 0.6 mm.

13. An electric razor according to claim 10 or 11, wherein at least some slots (33) have a width of from 0.2 to 0.3 mm.

14. An electric razor according to claim 10 or 11, wherein at least some slots (33) have a width of 0.3 to 0.5 mm.

15. An electric razor according to any one of claims 10 to 11, wherein the slots (33) are arranged in a regular pattern of long slots and short slots.

16. An electric razor according to any one of claims 10 to 15, wherein at least some slots (33) have a length of from 1 to 2.5 mm.

17. An electric razor according to any one of claims 10 to 16, wherein at least some slots (33) have a length of 1.5 to 2 mm.

18. An electric razor according to any one of claims 10 to 17, wherein at least some slots (33) have a length less than 1 mm.

19. An electric razor according to claim 18 wherein at least some slots (33) have a length of 0.4 to 0.7 mm.

20. An electric razor according to any one of claims 10 to 19, wherein at least two adjacent slots (33) are separated by a distance of 0.1 to 0.3 mm.

21. An electric razor according to any one of claims 10 to 20, wherein at least some slots (33) are disposed along the foil at a pitch of 0.3 to 0.7 mm.

22. An electric razor according to any one of the preceding claims wherein the first segment (5) of the foil cross-section extends through an arc of 60° to 120°, preferably 75° to 105°.

23. An electric razor according to claim 21, wherein the first segment (5) extends through an arc of about 90°.

24. An electric razor according to any one of claims 1 to 23, wherein the first and second segments (5, 6) are defined by a hyperbola.

25. An electric razor according to any one of the preceding claims, wherein the cross-sectional profile includes a rectilinear third segment (7) adjoining first segment (5) at the side remote from the second segment (6), the third segment (7) of the foil cross-section being taken through a flat-third foil portion (10).

26. An electric razor according to claim 25, when appended directly or indirectly to any one of claims 10 to 20, wherein at least some slots (33) continue into the third foil portion (10).

27. An electric razor according to any one of the preceding claims wherein the second segment (16) of the foil cross-section extends (6) through an arc of 60° to 120°, preferably 75° to 105°.

28. An electric razor according to claim 27, wherein the second segment (6) extends through an arc of about 90°.

29. An electric razor according to any one of claims 1 to 28, wherein the undercutter (23) is urged by spring force in a direction towards the peak (11) of the ridge (12).

30. An electric razor according to any one of claims 1 to 29, wherein the foil (1) is mounted in a frame (20), and the frame carries comb elements (34) for cooperation with the first foil portion.

31. An electric razor according to any one of claims 1 to 27, wherein the foil (1) is adjustable relative to a confronting component (50) to vary the exposure of the first foil portion (8) for contact with the skin.

32. An electric razor foil (1) including an area with apertures (2, 3), an outer surface for contact with the skin during shaving, and an inner surface for shearing cooperation with an undercutter (23) to shear hairs that protrude through the foil apertures, and a ridge (12) extending across the apertured area with first and second foil portions (8, 9) forming respective flanks of the ridge, the first foil portion (8) having apertures in the form of slots (3) elongate in a direction transverse to the ridge (12), and the foil having a cross-section transverse to the length of the ridge that is uniform along the length of the ridge, characterised in that the foil cross-section has an asymmetric arched profile, a first segment (5) of the cross-section taken through the first foil portion (8) has a radius of curvature in the range of 0.5 to 3.0 mm, and a second segment (6) of the cross-section taken through the second foil portion (9) is contiguous with the first segment and has a radius of curvature in the range of 5 to 30 mm.

33. An electric foil razor according to claim 32, wherein the second segment (6) of the foil cross-section comprises an arc with a radius in the range of 5 to 15 mm.

34. An electric razor foil according to claim 32, wherein the second segment (6) of the foil cross-section comprises an arc with a radius in the range of 7.5 to 12.5 mm.

35. An electric razor foil according to claim 32, wherein the second segment (6) of the foil cross-section comprises an arc with a radius of about 10 mm.

36. An electric razor foil according to any one of claims 32 to 35, wherein the first segment (5) of the foil cross-section comprises an arc with a radius of curvature not greater than 2 mm.

37. An electric razor foil according to any one of claims 32 to 36, wherein the first segment (5) of the foil cross-section comprises an arc with a radius of curvature in the range of 0.5 to 1.5 mm.

38. An electric razor foil according to any one of claims 32 to 37, wherein the first segment (5) of the foil cross-section comprises an arc with a radius of curvature of about 1 mm.

39. An electric razor foil according to any one of claims 32 to 38, wherein at least some slots (33) extend from a position substantially at the peak (11) of the ridge (12).

40. An electric razor foil according to any one of claims 32 to 39, wherein the outer surface of the foil has a smooth transition across the peak of the ridge of (12) from the first to the second foil portion.

41. An electric razor foil according to any one of claims 32 to 40, wherein the foil has a thickness at the first foil portion (8) substantially equal to the foil thickness at this second foil portion (9).

42. An electric razor foil according to any one of claims 32 to 41, wherein at least some slots (33) have a width of from 0.1 to 0.6 mm.

43. An electric razor foil according to any one of claims 32 to 42, wherein at least some slots (33) have a width of from 0.2 to 0.3 mm.

44. An electric razor foil according to any one of claims 32 to 43, wherein at least some slots (33) have a width of 0.3 to 0.5 mm.

45. An electric razor foil according to any one of claims 32 to 44, wherein the slots (33) are arranged in a regular pattern of long slots and short slots.

46. An electric razor foil according to any one of claims 32 to 45, wherein at least some slots (33) have a length of from 1 to 2.5 mm.

47. An electric razor foil according to any one of claims 32 to 46, wherein at least some slots (33) have a length of 1.5 to 2 mm.

48. An electric razor foil according to any one of claims 32 to 47, wherein at least some slots (33) have a length less that 1 mm.

49. An electric razor foil according to claim 48, wherein at least some slots (33) have a length of 0.4 to 0.7 mm.

50. An electric razor foil according to any one of claims 32 to 49, wherein at least two adjacent slots (33) are separated by a distance of 0.1 to 0.3 mm.

51. An electric razor foil according to any one of claims 32 to 50, wherein at least some slots (33) are disposed along the foil at a pitch of 0.3 to 0.7 mm.

52. An electric razor foil according to any one of the preceding claims wherein the first segment (5) of the foil cross-section extends through an arc of 60° to 120°, preferably 75° to 105°.

53. An electric razor foil according to claim 52, wherein the first segment (5) extends through an arc of about 90°.

54. An electric razor foil according to any one of claims 32 to 53, wherein the first and second segments (5, 6) of the foil cross-section are defined by a hyperbola.

55. An electric razor foil according to any one of claims 32 to 50, wherein the foil cross-section includes a rectilinear third segment (7) adjoining first segment (5) at the side remote from the second segment (6), the third segment (7) of the foil cross-section being taken through a flat third foil portion (10).

56. An electric razor foil according to claim 55, wherein at least some slots (33) continue into the third foil portion (10).

57. An electric razor foil according to any one of claims 32 to 56, wherein the second segment (6) of the foil cross-section extends through an arc of 60° to 120°, preferably 75° to 105°.

58. An electric razor foil according to claim 57, wherein the second segment (6) of the foil cross-section extends through an arc of about 90°.

59. An electric razor foil according to any one of claims 32 to 58, wherein the foil (1) is mounted in a frame (20), and the frame carries comb elements (34) for cooperation with the first foil portion.
